(19) United States
(12) Patent Application Publication
(10) Pub. No.: US 2004/0204156 A1
(43) Pub. Date: Oct. 14, 2004

(54) Mobile phone seat with a wireless transceiver module

(76) Inventor: Huo-Lu Tsai, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/158,437

(22) Filed: May 29, 2002

(51) Int. Cl. H04M 1/00; H04B 1/38

(52) U.S. Cl. 455/569.1; 455/575.1

(57) ABSTRACT

A mobile phone seat includes a seat body, a wireless transceiver module adapted to be connected to an external peripheral device, and a mounting device for mounting the wireless transceiver module movably on the seat body such that the wireless transceiver module is movable relative to the seat body so as to register a wireless transceiver of the wireless transceiver module with a wireless phone transceiver of a mobile phone on the seat body such that signals from the external peripheral device can be transmitted to the mobile phone.

### BACKGROUND OF THE INVENTION

1. Field of the Invention

The invention relates to a mobile phone seat, more particularly to a mobile phone seat with a wireless transceiver module.

2. Description of the Related Art

Nowadays, mobile phones are often provided with a wireless transmission function. When a mobile phone of this type is disposed on a mobile phone seat, the mobile phone can cooperate with an external peripheral device, such as a number dialing device, to achieve the purpose of hands-free dialing via a communications link between a wireless phone transceiver of the mobile phone and a wireless transceiver device connected to the external peripheral device. However, the location of a wireless phone transceiver of a mobile phone varies for different mobile phone manufacturers. Generally, it is located on the top side or one of the lateral sides of the mobile phone. The bottom side of the mobile phone is usually reserved for a battery charging slot and/or an earpiece plug, and is not used for the disposition of a wireless phone transceiver. There is thus a need to provide a mobile phone seat with an adjustable wireless transceiver module that can be conveniently registered with wireless phone transceivers of different mobile phones which can be accommodated on the mobile phone seat.

### SUMMARY OF THE INVENTION

Accordingly, the mobile phone seat of this invention is adapted for use with a mobile phone having front and rear walls opposite to each other relative to a first axis, a peripheral wall interconnecting the front and rear walls, and a wireless phone transceiver capable of wireless communication through the peripheral wall. The mobile phone seat comprises:

a seat body adapted to be mounted in a passenger room of an automobile;

a retaining unit mounted on the seat body and adapted to retain the mobile phone removably on the seat body;

a wireless transceiver module having a mounting end portion and a communicating end portion opposite to the mounting end portion in a direction parallel to the first axis, the mounting end portion being mounted on the seat body, the communicating end portion being provided with a wireless transceiver device, the wireless transceiver module being adapted to be connected to an external peripheral device and permitting wireless communication between the wireless phone transceiver of the mobile phone and the external peripheral device via the wireless transceiver device; and

a mounting device for mounting the mounting end portion of the wireless transceiver module movably on the seat body such that the wireless transceiver module is movable relative to the seat body in order to register the wireless transceiver device with the wireless phone transceiver of the mobile phone on the seat body.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a preferred embodiment of a mobile phone seat according to the present invention;

FIG. 2 is an assembled perspective view of the preferred embodiment of the present invention;

FIG. 3 is a schematic front view of the preferred embodiment of the present invention;

FIG. 4 is a schematic side view of the preferred embodiment of the present invention; and

FIG. 5 is an assembled perspective view of the preferred embodiment of the present invention in a state of use.

### DETAILED DESCRIPTION OF THE PREFERRED EMBODIMENT

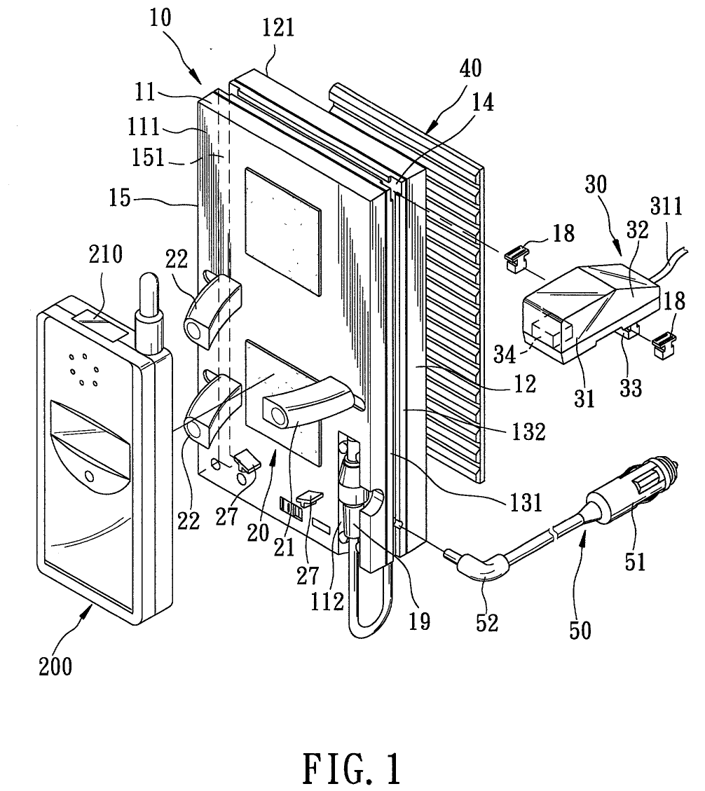

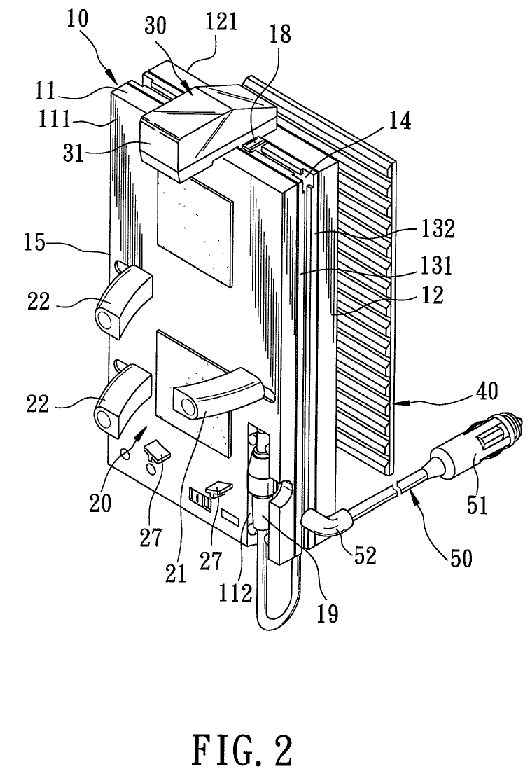

Referring to FIGS. 1 and 2, the preferred embodiment of a mobile phone seat according to the present invention is shown to be adapted for use with a mobile phone 200 equipped with a wireless phone transceiver 210 and having front and rear walls opposite to each other relative to a first axis, and a peripheral wall interconnecting the front and rear walls. The peripheral wall has opposite lateral portions opposite to each other relative to a second axis transverse to the first axis, and top and bottom portions opposite to each other relative to a third axis transverse to the first and second axes. The wireless phone transceiver 210 of the mobile phone 200 is capable of wireless communication through the top portion of the peripheral wall. The mobile phone seat comprises a seat body 10, a retaining unit 20, a wireless transceiver module 30, and amounting device.

The seat body 10 is adapted to be mounted in a passenger room of an automobile, and includes a front seat part 11 formed with a front side 111 and having a rear open end, a front cover plate 131 mounted on the front seat part 11 to close the rear open end, a rear seat part 12 formed with a rear side 121 and having a front open end, and a rear cover plate 132 mounted on the rear seat part 12 to close the front open end. The seat body 10 has a peripheral side 15 interconnecting the front and rear sides 111, 121. The front and rear cover plates 131, 132 are connected to each other and cooperate to form a clearance 14 between the front and rear seat parts 11, 12. The clearance 14 forms a slide groove 151 that extends along the peripheral side 15 of the seat body 10. The slide groove 151 serves as a slide rail.

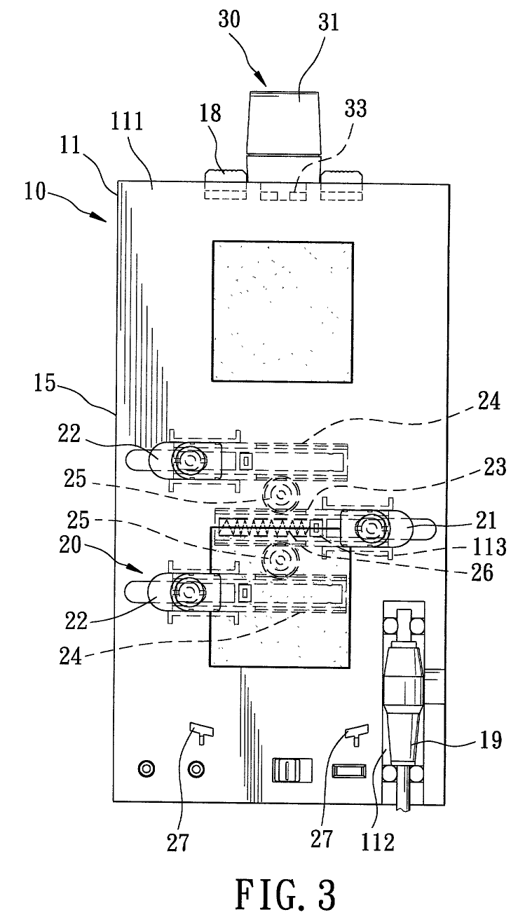

Referring further to FIG. 3, the retaining unit 20 is shown to include a first retainer 21, two second retainers 22, an inner rack 23, two outer racks 24, two sprockets 25, a biasing member 26, and two support blocks 27. The first and second retainers 21, 22 are mounted on the front side 111 of the seat body 10 and are adapted to engage the lateral portions of the peripheral wall of the mobile phone 200 for retaining the mobile phone 200 on the seat body 10. The first and second retainers 21, 22 are movable relative to each other to permit removal of the mobile phone 200 from the seat body 10. The inner and outer racks 23, 24 extend parallel to the second axis, are disposed in the seat body 10, are spaced apart from each other relative to the third axis, and are coupled to the first and second retainers 21, 22, respectively. The sprockets 25 are mounted in the seat body 10, are disposed between the inner and outer racks 23, 24, and mesh with the inner and outer racks 23, 24. The biasing member 26 is a compression spring in this embodiment, and has one end abutting against one end of the inner rack 23, and the other end abutting against a mounting block 113 in the seat body 10. The biasing member 26 serves to bias the first retainer 21 toward the second retainers 22. The support blocks 27 project from the front side 111 of the seat body 10 for supporting the bottom portion of the mobile phone 200 thereon. When the mobile phone 200 is to be disposed in a retaining space formed by the first and second retainers 21, 22, and the support blocks 27, the first and second retainers 21, 22 can be moved away from each other in directions parallel to the second axis. Thereafter, by virtue of the biasing member 26, the inner rack 23 will be pulled toward the mobile phone 200, thereby moving the outer racks 24 toward the mobile phone 200 via the meshing action of the sprockets 25, respectively. The first and second retainers 21, 22 engage the lateral portions of the peripheral wall of the mobile phone 200 at this time to retain the mobile phone 200 on the seat body 10.

The wireless transceiver module 30 is mounted on the seat body 10 and has a mounting end portion 32 and a communicating end portion 31 opposite to the mounting end portion 32 in a direction parallel to the first axis. The mounting end portion 32 is mounted on the seat body 10. The communicating end portion 31 is provided with a wireless transceiver device 34. The wireless transceiver module 30 is adapted to be connected to an external peripheral device, such as a number dialing device, via a signal transmission line 311, and permits wireless communication between the wireless phone transceiver 210 of the mobile phone 200 and the external peripheral device via the wireless transceiver device 34. The signal transmission line 311 extends into the clearance 14 in the seat body 10 in this embodiment.

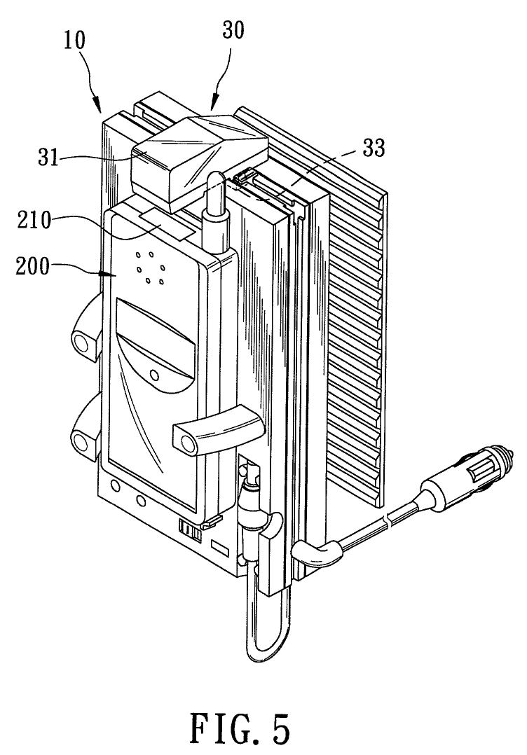

The mounting device is used for mounting the wireless transceiver module 30 movably on the seat body 10 such that the wireless transceiver module 30 is movable relative to the seat body 10 in order to register the wireless transceiver device 34 of the wireless transceiver module 30 with the wireless phone transceiver 210 of the mobile phone 200 on the seat body 10, as shown in FIG. 5. The mounting device 40 includes the slide rail, i.e. the slide groove 151 in the peripheral side 15 of the seat body 10, and a slide member 33 provided on the mounting end portion 32 of the wireless transceiver module 30 and slidably engaging the slide rail. In this embodiment, the mounting device further includes a pair of positioning blocks 18 mounted on the slide member 33. The positioning blocks 18 extend into the slide groove 151 for friction engagement with the seat body 10 to resist unforced movement of the wireless transceiver module 30 relative to the seat body 10.

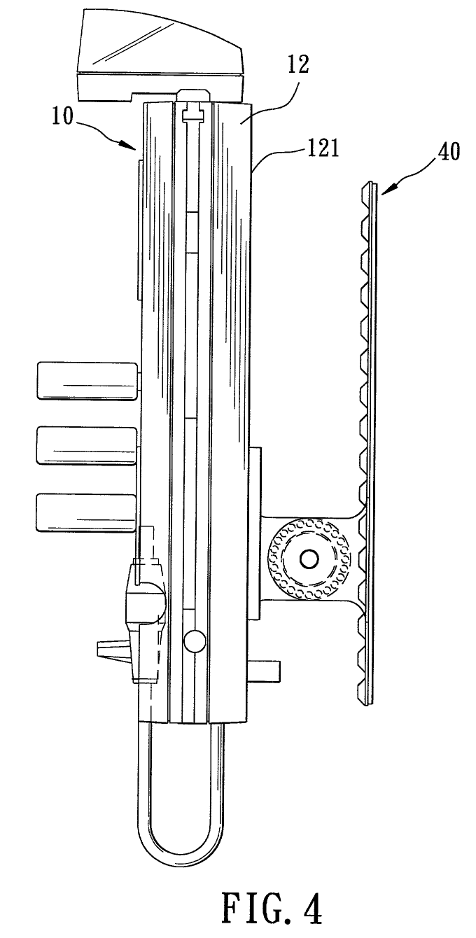

Referring to FIG. 4, preferably, a mounting plate 40 is coupled pivotally to the rear side 121 of the seat body 10 and is adapted to mount the seat body 10 in the passenger room of the automobile such that the seat body 10 can be retained at different inclinations.

Referring back to FIG. 1, in the preferred embodiment, there is provided a cigarette lighter adapter plug 50 that includes a first plug end 51 and a second plug end 52. The first plug end 51 is adapted to be plugged into a cigarette lighter socket of the automobile. The second plug end 52 is adapted to be plugged into the seat body 10 so that power can be supplied to the wireless transceiver module 30.

Preferably, the mobile phone seat further includes a battery charging plug 19 to permit charging of the mobile phone 200 in a known manner. The front side 111 of the seat body 10 is formed with a recess 112 for removably retaining the battery charging plug 19 therein.

Since the wireless transceiver module 30 in this invention can be adjusted to different positions on the peripheral side 15 of the seat body 10, the mobile phone seat can be readily configured for establishing wireless communications links with different mobile phones.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A mobile phone seat adapted for use with a mobile phone having front and rear walls opposite to each other relative to a first axis, a peripheral wall interconnecting the front and rear walls, and a wireless phone transceiver capable of wireless communication through the peripheral wall, said mobile phone seat comprising:
a seat body adapted to be mounted in a passenger room of an automobile;
a retaining unit mounted on said seat body and adapted to retain the mobile phone removably on said seat body;
a wireless transceiver module having a mounting end portion and a communicating end portion opposite to said mounting end portion in a direction parallel to the first axis, said mounting end portion being mounted on said seat body, said communicating end portion being provided with a wireless transceiver device, said wireless transceiver module being adapted to be connected to an external peripheral device and permitting wireless communication between the wireless phone transceiver of the mobile phone and the external peripheral device via said wireless transceiver device; and
a mounting device for mounting said mounting end portion of said wireless transceiver module movably on said seat body such that said wireless transceiver module is movable relative to said seat body in order to register said wireless transceiver device with the wireless phone transceiver of the mobile phone on said seat body.

2. The mobile phone seat as claimed in claim 1, wherein said seat body has a front side, a rear side opposite to said front side, and a peripheral side interconnecting said front and rear sides,
said mounting device including a slide rail extending along said peripheral side of said seat body, and a slide member provided on said mounting end portion of said wireless transceiver module and slidably engaging said slide rail.

3. The mobile phone seat as claimed in claim 2, wherein said slide rail is in the form of a slide groove that extends along said peripheral side of said seat body, said slide member on said wireless transceiver module being in sliding engagement with said slide groove.

4. The mobile phone seat as claimed in claim 3, further comprising a positioning block mounted on said slide member and extending into said slide groove for friction engagement with said seat body to resist unforced movement of said wireless transceiver module relative to said seat body.

5. The mobile phone seat as claimed in claim 2, further comprising a positioning block mounted on said slide member and in friction engagement with said slide rail to resist unforced movement of said wireless transceiver module relative to said seat body.

6. The mobile phone seat as claimed in claim 1, wherein said seat body has a front side, and said retaining unit includes first and second retainers mounted on said front side of said seat body and adapted to engage opposite lateral portions of the peripheral wall of the mobile phone for retaining the mobile phone on said seat body, said first and second retainers being movable relative to each other to permit removal of the mobile phone from said seat body.

7. The mobile phone seat as claimed in claim 6, wherein said first retainer is mounted movably on said front side of said seat body and is movable relative to said second retainer in a direction parallel to a second axis that is transverse to the first axis.

8. The mobile phone seat as claimed in claim 7, wherein said retaining unit further includes a biasing member for biasing said first retainer toward said second retainer.

9. The mobile phone seat as claimed in claim 6, wherein said first and second retainers are mounted movably on said front side of said seat body and are movable relative to said seat body in directions parallel to a second axis that is transverse to the first axis from a releasing position, where said first and second retainers move away from each other to permit removal of the mobile phone from said seat body, to a retaining position, where said first and second retainers move toward each other to engage the lateral portions of the peripheral wall of the mobile phone, respectively.

10. The mobile phone seat as claimed in claim 6, wherein said retaining unit further includes:
inner and outer racks extending parallel to a second axis transverse to the first axis, disposed in said seat body, spaced apart from each other relative to a third axis transverse to the first and second axes, and coupled to said first and second retainers, respectively; and
a sprocket mounted in said seat body, disposed between said inner and outer racks, and meshing with said inner and outer racks.

11. The mobile phone seat as claimed in claim 6, wherein said seat body further has a support block projecting from said front side and adapted to support the mobile phone thereon.

12. The mobile phone seat as claimed in claim 1, wherein said seat body has a rear side, said mobile phone seat further comprising a mounting plate coupled pivotally to said rear side of said seat body and adapted to mount said seat body in the passenger room of the automobile.
